(19) United States
(12) Patent Application Publication
(10) Pub. No.: US 2017/0275202 A1
(43) Pub. Date: Sep. 28, 2017

(54) COMPOSITIONS COMPRISING CURABLE RESIN FOR ANTI-STATIC FLOORING

(71) Applicant: ASHLAND LICENSING AND INTELLECTUAL PROPERTY LLC, Dublin, OH (US)

(72) Inventors: José Luís Miquel PERAIRE, Barcelona (ES); Makan NOROZE, Valencia (ES); Javier Perez MARTINEZ, La Rioja (ES)

(73) Assignee: ASHLAND LICENSING AND INTELLECTUAL PROPERTY LLC, Dublin, OH (US)

(21) Appl. No.: 15/510,814

(22) PCT Filed: Sep. 11, 2015
(86) PCT No.: PCT/US2015/049688

§ 371 Date: Mar. 13, 2017

Related U.S. Application Data
(60) Provisional application No. 62/049,673, filed on Sep. 12, 2014.

(51) Int. Cl. C04B 26/18; C04B 20/10; C04B 22/06; C04B 24/12; C04B 22/04

(52) U.S. Cl. CPC C04B 26/18; C04B 24/12; C04B 22/04; C04B 22/068; C04B 20/1037; C04B 2111/60

(57) ABSTRACT

The invention relates to a composition for making flooring material comprising resin and particles comprising ammonium quaternary salt. The resin is generally an unsaturated polyester resin. The flooring materials, or engineered stone slabs from which the flooring materials or other material can be formed, are generally made from combining the resin, particles, inorganic particulate material and an initiator and allowing the resin to cure. The flooring material composition may be cobalt free. Metal catalysts may be used to cure the resin.

The invention relates to compositions for making flooring materials and flooring materials having antistatic properties. The composition and flooring materials comprise a resin formulation and particles comprising ammonium quaternary salts. The composition may be formed into flooring material by applying a conventional Brenton manufacturing process to make an engineered stone flooring surface from the resin, particles, and other materials.

Flooring has conventionally been made from a wide variety of natural and human-made materials. Polyester resins have been used in making flooring materials, an example of which are flooring materials made from engineered stone slabs wherein a resin formulation is mixed with crushed stone, typically quartz fillers and/or quartz aggregates of defined particle sizes.

Flooring made with polyester resin, are prone to the generation of static electricity by people walking across the floor. Conventional engineered stone material, from which flooring materials can be made, using standard polyester resins and fillers have electrical resistivity values within the insulative zone, generally greater than 10¹¹Ω for 100V and 500V voltage levels. Several concepts have been developed to address the static buildup in flooring made with polyester resin. For example, flooring can be installed with ground paths, metallic bands installed with the flooring, to connect to the grounding system of the structure where the floor is installed in order to dissipate the static building up before a person touches a metallic surface. Such ground paths, however, cause aesthetic concerns with the flooring and add to installation costs. Also, anti-static detergents can be applied to existing floors but this can increases maintenance costs. Also certain electrically conductive materials, such as metals, oxides and/or silicon can be added to flooring materials.

There is a demand for methods for the preparation of engineered stone material that overcome the drawbacks of the prior art. The engineered stone material should have electrical resistivity values below the insulative zone, preferably not greater than 10⁹Ω for 100V and 500V voltage levels, and should not be hazardous to health and environment.

This object has been achieved by the subject-matter of the patent claims.

It has been surprisingly found that by adding particles comprising ammonium quaternary salts the properties of engineered stone material can be substantially improved, particularly with respect to anti-static properties.

All parts and percentages set forth in this specification and the appended claims are on a weight-by-weight basis unless otherwise specified.

The invention pertains to compositions for use in making flooring materials and flooring materials comprising a resin formulation and particles comprising ammonium quaternary salts. Flooring materials comprising the composition have antistatic properties with electric resistivity values within the dissipative established zone, such as about 10⁵Ω to about 10¹¹Ω, typically in the range of about 10⁷Ω to about 10¹⁰Ω for 100V and 500V voltage levels.

A first aspect of the invention relates to a flooring material composition comprising
(A) an unsaturated polyester resin formulation comprising
   (i) an unsaturated polyester resin component; preferably a reaction product of a mixture comprising at least 1, 2 or 3 diols selected from the group consisting of propylene glycol, dipropylene glycol, ethylene glycol, and diethylene glycol; and at least 1, 2, 3 or 4 acids selected from the group consisting of maleic acid, isopthalic acid, phthalic acid, and adipic acid, or their acid anhydrides;
   (ii) a metal catalyst capable of catalyzing curing of the unsaturated polyester resin component; preferably a zinc salt of a carboxylic acid, more preferably a zinc salt of a C₁-₂₀ carboxylic acid, still more preferably a zinc salt of a C₆-₁₂ carboxylic acid, most preferably zinc octanoate;
   (iii) a quaternary ammonium salt; preferably a benzyl-N,N,N-trialkylammonium salt or a N,N,N,N-tetraalkylammonium salt; and
   (iv) optionally, one or more additives selected from the group consisting of pigments, accelerators, co-promoters, dispersing agents, UV absorbers, stabilizers, inhibitors and rheology modifiers;
(B) particles, preferably encapsulated particles, more preferably encapsulated nanoparticles, particularly preferably microencapsulated nanoparticles, comprising ammonium quaternary salt;
(C) an inorganic particulate material; and
(D) an initiator; preferably a peroxide; more preferably cumene hydroperoxide and/or methyl isobutyl ketone peroxide.

For purposes of this specification and the appended claims, antistatic and resistivity measurements were made applying UNE-EN 61340-2-1, Measurement Methods: Test to Measure the Ability of Materials and Product to Dissipate Static Electric Charge, UNE-EN 61340-2-3, Method and Test for Determining the Resistance and Resistivity of a Solid Planar Material Used to Avoid Electrostatic Charge Accumulation, UNE-EN 14041:2004, Resilient, textile and laminate floor coverings—Essential characteristics, and ASTM F150-Standard Test Method for Electrical Resistance of Conductive and Static Dissipative Resilient Flooring. These standards UNE-EN 61340-2-1, UNE-EN 61340-2-3, UNE-EN 14041:2004, and ASTM F150 are incorporated herein by reference in their entirety.

Typically, the flooring materials are made by curing the resin formulation that is mixed with crushed stone, typically quartz fillers and/or quartz aggregates of defined particle sizes, in addition to the (B) particles comprising ammonium quaternary salt, which are preferably encapsulated. The Brenton manufacturing process may be used and an example of this process is described in U.S. Pat. No. 8,026,298 which is incorporated herein by reference in its entirety.

Preferably, the content of the unsaturated polyester resin formulation (total content of (i), (ii), (iii) and (iv)) is about 0.1 wt.-% to about 30 wt.-%, more preferably about 5 wt.-% to about 20 wt.-%, relative to the total weight of the flooring material composition. Preferably, the content of the unsaturated polyester resin formulation (total content of (i), (ii), (iii) and (iv)) is within the range of about 10±7 wt.-%, more preferably about 10±6 wt.-%, still more preferably about 10±5 wt.-%, yet more preferably about 10±4 wt.-%, even more preferably about 10±3 wt.-%, most preferably about 10±2 wt.-%, and in particular about 10±1 wt.-%, relative to the total weight of the flooring material composition.

The resin formulation comprises resin, such as unsaturated polyester resin (UPR), vinyl ester resin (VER) and epoxy resin, as well as other materials having ethylenic unsaturation. These resins are characterized by a polymerizable C═C double bond, generally in conjugation with a carbonyl bond. One skilled in the art will appreciate that there are many different processes and methods for making resins having ethylenic unsaturation that may be applied within the scope of the invention.

UPRs are typically made of an ethylenically unsaturated polycarboxylic acid or its corresponding anhydride and optionally other acids with a polyol in the presence of a condensation and/or isomerization catalyst that reacts the completed UPR with a saturated monohydric alcohol, optionally in the presence of a transesterification catalyst. Examples of dicarboxylic acids and corresponding anhydrides containing ethylenic unsaturation useful in the invention include dicarboxylic acids and corresponding anhydrides such as itaconic anhydride, maleic acid, fumaric acid, itaconic acid and maleic anhydride. Examples of other useful acids and anhydrides include adipic acid, phthalic acid, isophthalic acid, terephthalic acid, tetrahydrophthalic anhydride, phthalic anhydride, nadic anhydride, methylnadic anhydride, hexahydrophthalic anhydride, dimethyl terephthalate, recycled terephthalate (PET) and the like. Examples of polyols and glycols include ethylene glycol, propylene glycol, 1,3-propanediol, 1,4-propanediol, 1,4-butanediol, 2,2-dimethyl-1,3-propanediol, 2-methyl-1,3-propanediol, glycol ethers such as diethylene glycol and dipropylene glycol, and polyoxyalkylene glycol. Triols and higher functional polyols such as glycerol, trimethylol propane and oxyalkylated adducts thereof can also be used.

Also, chlorendics prepared from chlorine containing anhydrides or glycols or triols in the preparation of the UPR may be used. Dicyclopentadiene (DCPD) UPR resins obtained either by modification of any of the above resin types via Diels-Alder reaction with cyclopentadiene, or obtained by first reacting a diacid, such as maleic acid, with dicyclopentadiene, followed by the usual steps for manufacturing UPR, further referred to as DCPD-maleate resin, may also be used.

VER has polymerizable unsaturated sites, predominantly in the terminal position, and is prepared by reaction of epoxy oligomers or polymers (e.g. diglycidyl ether of bisphenol-A, epoxies of the phenol-novolac type, or epoxies based on tetrabromobisphenol-A) with for example (meth)acrylic acid or (meth)acrylamide. VER is an oligomer or polymer containing at least one (meth)acrylate functional end group, also known as (meth)acrylate functional resins. This also includes the class of vinyl ester urethane resins (also referred to as urethane (meth)acrylate resins) which are typically prepared from reaction of isocyanates, hydroxyl acrylates or methacyrlates. These VER resins, often, contain reactive monomers, such as styrene, methyl methacrylate, or other methacrylates or acrylates. In addition, VER resins include those obtained by reaction of an epoxy oligomer or polymer with methacrylic acid or methacrylamide, preferably with methacrylic acid.

Epoxy resins are typically diglycidyl ethers of bisphenol A which can be made by reacting epichlorohydrin with bisphenol A in the presence of an alkaline catalyst. By controlling the operating conditions and varying the ratio of epichlorohydrin to bisphenol A, products of different molecular weight can be made. Other usable epoxy resins include the diglycidyl ethers of other bisphenol compounds such as bisphenol B, F, G and H.

Generally, the resin is cured in the presence of a catalyst in the process for making the flooring materials, which can be formed directly from the resin or the resin can be made into engineered stone slabs which slabs are formed into flooring material. One such conventional catalyst is cobalt and the invention encompasses using cobalt for making the flooring material. However, is certain aspects of the invention, no cobalt is used for making the flooring material, such that the composition is cobalt free. For the purpose of the invention, “cobalt free” means that the system contains substantially no cobalt, preferably at most 10 ppm, more preferably at most 5 ppm, most preferably at most 1 ppm cobalt, and in particular no detectable cobalt at all.

In accordance with certain aspects of the invention a prepromoted UPR which is cobalt free may be used in the resin formulation to make the flooring materials. Preferably, the flooring materials as such are cobalt free. The prepromoted resin formulation comprises UPR, a metal catalyst capable of catalyzing curing of the UPR component, quaternary ammonium salt; and, optionally, reactive diluent and/or one or more additives selected from the group consisting of, accelerators, co-promoters, dispersing agents, UV absorbers, stabilizers, inhibitors and rheology modifiers. The prepromoted resin formulation is combined with the particles, preferably encapsulated particles, comprising ammonium quaternary salts which are preferably present as nanoparticles, inorganic particulate material and initiator to make a composition that can be used to make flooring material and/or engineering stone slabs, such as in a Brenton process. This system is preferably cobalt free.

For the purpose of the invention, a “prepromoted” resin already contains the metal catalyst as promoter, but not yet the initiator for the radical reaction that causes curing. The prepromoted resin has long shelf-life and may be marketed as precursor. The initiator is then shortly added before the prepromoted resin is employed in the production of the final product.

Typically, the flooring material is made from a flooring material composition comprising a resin formulation, particles comprising ammonium quaternary salts, aggregate material, such as quartz filler and/or quartz aggregates and other optional components, particularly pigment. In embodiments of the invention, the resin formulation is a prepromoted UPR that is cobalt free in that resin formulation comprises zinc salts or copper salts as catalysts in place of conventional cobalt salts. Thus, when preparing flooring materials with the prepromoted UPR, only the initiator (such as peroxide) needs to be added, but not the metal catalyst (promoter).

UPR is known to a skilled person and for the purposes of the invention not particularly limited. Typically, the UPR components according to the invention are characterized by a polymerizable C═C double bond, optionally in conjugation with a carbonyl bond. These UPR components are obtained by the condensation of carboxylic acid monomers with polyhydric alcohol monomers. The polyester may then be dissolved in a reactive monomer, such as styrene, to obtain a solution that may then be crosslinked. One skilled in the art will appreciate that there are many different processes and methods for making UPR and other resins having ethylenic unsaturation that may be applied within the scope of the invention.

The UPR in the resin formulation may be obtained by reacting a mixture comprising a multicarboxylic acid component (free acid, salt, anhydride) and a polyhydric alcohol component, wherein the multicarboxylic acid component and/or the polyhydric alcohol component comprises ethylenic unsaturation. This mixture may also comprise saturated or unsaturated, aliphatic or aromatic monocarboxylic acids and/or saturated or unsaturated, aliphatic or aromatic monoalcohols in order to adjust the average molecular weight of the polyester molecules.

Alternatively, the UPR is obtained by reacting a mixture comprising a polyol and a carboxylic acid, a carboxylic acid ester and/or a carboxylic acid anhydride, i.e. the UPR is derived from a monomer composition (in this specification also referred to as “mixture”) comprising a polyol and a carboxylic acid, a carboxylic acid ester and/or a carboxylic acid anhydride. In a preferred embodiment, the mixture comprises a polyol and a polycarboxylic acid, a polycarboxylic acid ester and/or a polycarboxylic acid anhydride, i.e. the UPR is the condensation product of one or more polycarboxylic acids, polycarboxylic acid esters and/or polycarboxylic acid anhydrides with one or more polyols. More preferably, the mixture comprises a polyol and a polycarboxylic acid and/or a polycarboxylic acid anhydride, i.e. the UPR is the condensation product of one or more polycarboxylic acids and/or polycarboxylic acid anhydrides with one or more polyols.

In another embodiment, the mixture comprises a carboxylic acid, a carboxylic acid ester and/or a carboxylic acid anhydride, wherein the carboxylic acid, the carboxylic acid ester and/or the carboxylic acid anhydride is selected from aliphatic and aromatic polycarboxylic acids and/or the esters and anhydrides thereof, wherein the term “aliphatic” includes acyclic and cyclic, saturated and unsaturated polycarboxylic acids and the esters and anhydrides thereof. Preferably, the carboxylic acid, the carboxylic acid ester and/or the carboxylic acid anhydride is selected from unsaturated and aromatic polycarboxylic acids and/or the esters and anhydrides thereof. More preferably, the carboxylic acid, the carboxylic acid ester and/or the carboxylic acid anhydride is selected from unsaturated polycarboxylic acids and/or the esters and anhydrides thereof.

Further, the mixture may comprise a carboxylic acid, a carboxylic acid ester and/or a carboxylic acid anhydride, wherein the carboxylic acid, the carboxylic acid ester and/or the carboxylic acid anhydride is selected from unsaturated polycarboxylic acids and/or the esters and anhydrides thereof, and used in combination with a second carboxylic acid, carboxylic acid ester and/or carboxylic acid anhydride, which is selected from aliphatic and/or aromatic polycarboxylic acids and/or the esters and anhydrides thereof. Preferably, the carboxylic acid, the carboxylic acid ester and/or the carboxylic acid anhydride is selected from unsaturated polycarboxylic acids and/or the esters and anhydrides thereof, and used in combination with a second carboxylic acid, carboxylic acid ester and/or carboxylic acid anhydride, which is selected from saturated and/or aromatic polycarboxylic acids and/or the esters and anhydrides thereof. More preferably, the carboxylic acid, the carboxylic acid ester and/or the carboxylic acid anhydride is selected from unsaturated polycarboxylic acids and/or the esters and anhydrides thereof, and used in combination with a second carboxylic acid, carboxylic acid ester and/or carboxylic acid anhydride, which is selected from aromatic polycarboxylic acids and/or the esters and anhydrides thereof. Even more preferably, the carboxylic acid, the carboxylic acid ester and/or the carboxylic acid anhydride is selected from unsaturated polycarboxylic acids and/or the esters and anhydrides thereof, and used in combination with a second carboxylic acid, carboxylic acid ester and/or carboxylic acid anhydride, which is selected from aromatic polycarboxylic acids and/or the esters and anhydrides thereof, wherein the second carboxylic acid, carboxylic acid ester and/or carboxylic acid anhydride has a limited weight proportion in the reactive unsaturated polyester resin system compared to the carboxylic acid, the carboxylic acid ester and/or the carboxylic acid anhydride selected from unsaturated polycarboxylic acids and/or the esters and anhydrides thereof, the weight ratios (second carboxylic acid, carboxylic acid ester and/or carboxylic acid anhydride: carboxylic acid, the carboxylic acid ester and/or the carboxylic acid anhydride selected from unsaturated polycarboxylic acids and/or the esters and anhydrides thereof) being less than about 0.8:1, preferably less than about 0.5:1, more preferably about less than 0.2:1, even more preferably less than about 0.1:1, and most preferably less than about 0.05:1. The use of the saturated and/or aromatic polycarboxylic acids, polycarboxylic acid esters and/or polycarboxylic acid anhydrides in combination with unsaturated polycarboxylic acids, polycarboxylic acid esters and/or polycarboxylic acid anhydrides may serve to decrease the crosslink density after curing of the UPR formulation, and consequently the cured product will typically be more flexible, shock resistant, unbrittle, and the like.

In another embodiment, the mixture comprises a carboxylic acid, a carboxylic acid ester and/or a carboxylic acid anhydride, wherein the carboxylic acid, the carboxylic acid ester and/or the carboxylic acid anhydride is exclusively selected from unsaturated polycarboxylic acids and/or the esters and anhydrides thereof, and a combined use with another carboxylic acid, carboxylic acid ester and/or carboxylic acid anhydride is excluded. Preferably, the mixture exclusively comprises an unsaturated polycarboxylic acid, an unsaturated polycarboxylic acid ester or an unsaturated polycarboxylic acid anhydride. More preferably, the mixture exclusively comprises an unsaturated polycarboxylic acid or an unsaturated polycarboxylic acid anhydride. Most preferably, the mixture exclusively comprises an unsaturated polycarboxylic acid anhydride. The exclusive use of unsaturated polycarboxylic acids, polycarboxylic acid esters and/or polycarboxylic acid anhydrides typically results in a high crosslink density after curing, and consequently in a high resin stability.

The multicarboxylic acid component can be selected from the group consisting of aliphatic dicarboxylic acids, aliphatic tricarboxylic acids, aliphatic tetracarboxylic acids, aromatic dicarboxylaic acids, aromatic tricarboxylic acids, aromatic tetracarboxylic acids, and their corresponding acid anhydrides. A skilled person recognizes that the multicarboxylic acids may also be employed in form of esters, e.g. methyl esters or ethyl esters, in the corresponding transesterification reactions.

Exemplary unsaturated polycarboxylic acids include chloromaleic acid, citraconic acid, fumaric acid, itaconic acid, maleic acid, mesaconic acid, and methyleneglutaric acid. Preferred unsaturated polycarboxylic acids are fumaric acid, itaconic acid, maleic acid and mesaconic acid, glutaconic acid, traumatic acid, muconic acid, nadic acid, methylnadic acid, tetrahydrophthalic acid, and hexahydrophthalic acid. More preferred unsaturated polycarboxylic acids are fumaric acid and maleic acid. The most preferred unsaturated polycarboxylic acid is maleic acid. Exemplary unsaturated polycarboxylic acid esters can be derived from chloromaleic acid, citraconic acid, fumaric acid, itaconic acid, maleic acid, mesaconic acid, and methyleneglutaric acid. Preferred unsaturated polycarboxylic acids are fumaric acid, itaconic acid, maleic acid and mesaconic acid. Exemplary unsaturated polycarboxylic acid anhydrides can be derived from chloromaleic acid, citraconic acid, fumaric acid, itaconic acid, maleic acid, mesaconic acid, and methyleneglutaric acid. Preferred unsaturated polycarboxylic acid anhydrides are the unsaturated polycarboxylic acid anhydrides of chloromaleic acid, maleic acid, citraconic acid, and itaconic acid. More preferred unsaturated polycarboxylic acid anhydrides are maleic anhydride, citraconic anhydride, and itaconic anhydride. The most preferred unsaturated polycarboxylic acid anhydride is maleic anhydride.

Exemplary saturated polycarboxylic acids include adipic acid, chlorendic acid, dihydrophthalic acid, dimethyl-2,6-naphthenic dicarboxylic acid, d-methyl glutaric acid, dodecanedicarboxylic acid, glutaric acid, hexahydrophthalic acid, oxalic acid, malonic acid, suberic acid, azelaic acid, nadic acid, pimelic acid, sebacic acid, succinic acid, tetrahydrophthalic acid, 1,2-cyclohexane dicarboxylic acid, 1,3-cyclohexane dicarboxylic acid, 1,4-cyclohexane dicarboxylic acid, and Diels-Alder adducts made from maleic anhydride and cyclopentadiene. Preferred saturated polycarboxylic acids are succinic acid, glutaric acid, d-methyl glutaric acid, adipic acid, sebacic acid, and pimelic acid. More preferred saturated polycarboxylic acids are adipic acid, succinic acid, and glutaric acid.

Exemplary saturated polycarboxylic acid esters can be derived from adipic acid, chlorendic acid, dihydrophthalic acid, dimethyl-2,6-naphthenic dicarboxylic acid, d-methyl glutaric acid, dodecanedicarboxylic acid, glutaric acid, hexahydrophthalic acid, nadic acid, pimelic acid, sebacic acid, succinic acid, tetrahydrophthalic acid, 1,2-cyclohexane dicarboxylic acid, 1,3-cyclohexane dicarboxylic acid, 1,4-cyclohexane dicarboxylic acid, and Diels-Alder adducts made from maleic anhydride and cyclopentadiene.

Exemplary saturated polycarboxylic acid anhydrides can be derived from adipic acid, chlorendic acid, dihydrophthalic acid, dimethyl-2,6-naphthenic dicarboxylic acid, dimethylglutaric acid, dodecanedicarboxylic acid, glutaric acid, hexahydrophthalic acid, nadic acid, pimelic acid, sebacic acid, succinic acid, tetrahydrophthalic acid, 1,2-cyclohexane dicarboxylic acid, 1,3-cyclohexane dicarboxylic acid, 1,4-cyclohexane dicarboxylic acid, and Diels-Alder adducts made from maleic anhydride and cyclopentadiene. Preferred saturated polycarboxylic acid anhydrides are the saturated polycarboxylic acid anhydrides of chlorendic acid, dihydrophthalic acid, dimethylglutaric acid, glutaric acid, hexahydrophthalic acid, nadic acid, succinic acid and tetrahydrophthalic acid. More preferred saturated polycarboxylic acid anhydrides are dihydrophthalic anhydride, hexahydrophthalic anhydride, tetrahydrophthalic anhydride, and succinic anhydride.

Exemplary aromatic polycarboxylic acids include isophthalic acid, phthalic acid, terephthalic acid, tetrachlorophthalic acid, trimellitic acid, 1,2,4,5-benzenetetracarboxylic acid, and 1,2,4-benzenetricarboxylic acid. Preferred aromatic polycarboxylic acids are isophthalic acid, phthalic acid, terephthalic acid, and tetrachlorophthalic acid. More preferred aromatic polycarboxylic acids are isophthalic acid, and phthalic acid. The most preferred aromatic polycarboxylic acid is isophthalic acid.

Exemplary aromatic polycarboxylic acid esters can be derived from isophthalic acid, phthalic acid, terephthalic acid, tetrachlorophthalic acid, trimellitic acid, 1,2,4,5-benzenetetracarboxylic acid, and 1,2,4-benzenetricarboxylic acid. Exemplary aromatic polycarboxylic acid anhydrides can be derived from isophthalic acid, phthalic acid, terephthalic acid, tetrachlorophthalic acid, trimellitic acid, 1,2,4,5-benzenetetracarboxylic acid, and 1,2,4-benzenetricarboxylic acid. Preferred aromatic polycarboxylic acid anhydrides are the aromatic polycarboxylic acid anhydrides of phthalic acid and tetrachlorophthalic acid. The most preferred aromatic polycarboxylic acid anhydride is phthalic anhydride.

In another embodiment, the mixture comprises a blend of a carboxylic acid, a carboxylic acid ester and/or a carboxylic acid anhydride, wherein the carboxylic acid, the carboxylic acid ester and/or the carboxylic acid anhydride is selected from aliphatic and aromatic dicarboxylic acids and/or the esters and anhydrides thereof, wherein the term “aliphatic” includes acyclic and cyclic, saturated and unsaturated dicarboxylic acids and the esters and anhydrides thereof. Preferably, a first carboxylic acid, the carboxylic acid ester and/or carboxylic acid anhydride is selected from unsaturated dicarboxylic acids and/or esters and anhydrides thereof, and is used in combination with a second carboxylic acid, carboxylic acid ester and/or carboxylic acid anhydride, which is selected from saturated and/or aromatic polycarboxylic acids and/or the esters and anhydrides thereof. More preferably, a first carboxylic acid and/or a carboxylic acid anhydride selected from fumaric acid, maleic acid, and maleic anhydride is used in combination with a second carboxylic acid and/or carboxylic acid anhydride selected from isophthalic acid, phthalic acid, terephthalic acid, and phthalic anhydride. More preferably, maleic anhydride is used in combination with isophthalic acid.

In an aspect of the invention, the mixture further comprises a monocarboxylic acid, such as in amounts from about 0.01 wt.-% to about 10 wt.-%, more preferably from about 0.01 wt.-% to about 2 wt.-%, all by weight of the UPR formulation. Exemplary monocarboxylic acids include acrylic acid, benzoic acid, ethylhexanoic acid, and methacrylic acid. Preferred monofunctional carboxylic acids are acrylic acid and methacrylic acid.

The polyhydric alcohol can be selected from the group consisting of aliphatic diols, aliphatic triols, aliphatic tetraols, aromatic diols, aromatic triols and aromatic tetraols. Examples of aliphatic polyhydric alcohols include but are not limited to ethylene glycol, propylene glycol, 1,3-propanediol, 1,4-propanediol, 1,4-butanediol, 2,2-dimethyl-1,3-propanediol, 2-methyl-1,3-propanediol, glycerol, trimethylol propane and oxyalkylated adducts thereof such as glycol ethers, e.g. diethylene glycol, dipropylene glycol, and polyoxyalkylene glycol. Examples of aromatic polyhydric alcohols include but are not limited to bisphenol A, bisphenol AF, bisphenol AP, bisphenol B, bisphenol BP, bisphenol C, bisphenol E, bisphenol F, bisphenol FL, bisphenol G, bisphenol M, bisphenol P, bisphenol PH, bisphenol S, bisphenol TMC, and bisphenol Z. In an embodiment, the polyol is selected from aliphatic and aromatic polyols, wherein the term “aliphatic” includes acyclic and cyclic, saturated and unsaturated polyols. Preferably, the polyol is selected from aliphatic polyols. More preferably, the polyols are selected from aliphatic polyols having from 2 to 12 carbon atoms. Still more preferably, the polyols are selected from diols having from 2 to 10 carbon atoms, most preferably from diols having 3, 4, 5, 6, 7, 8, 9 or 10 carbon atoms. It is particularly preferred that the polyol is a diol having 3 carbon atoms.

Exemplary diols include alkanediols, butane-1,4-diol, 2-butyl-2-ethyl-1,3-propanediol (BEPD), 1,3-butylene glycol, butane-1,4-diol, cyclohexane-1,2-diol, cyclohexane dimethanol, diethylenglycol, 2,2-dimethyl-1,4-butanediol, 2,2-dimethylheptanediol, 2,2-dimethyloctanediol, 2,2-dimethylpropane-1,3-diol, dipentaerythritol, dipropylene glycol, di-trimethylolpropane, ethyleneglycol, hexane-1,6-diol, 2-methyl-1,3-propanediol, neopentyl glycol, 5-norbornene-2,2-dimethylol, 2,3-norbornene diol, oxa-alkanediols, pentaerythritol, poly-ethylenepropane-3-diol, 1,2-propanediol, 1,2-propyleneglycol, triethyleneglycol, trimethylolpropane, tripentaerythirol, 2,2,4-trimethyl-1,3-pentanediol, and 2,2-bis(p-hydroxycyclohexyl)-propane. In a preferred embodiment, the polyol is a diol selected from the group consisting of butane-1,4-diol, 2-butyl-2-ethyl-1,3-propanediol (BEPD), 1,3-butylene glycol, cyclohexane-1,2-diol, cyclohexane dimethanol, diethylenglycol, 2,2-dimethyl-1,4-butanediol, 2,2-dimethylheptanediol, 2,2-dimethyloctanediol, 2,2-dimethylpropane-1,3-diol, dipentaerythritol, dipropylene glycol, di-trimethylolpropane, hexane-1,6-diol, 2-methyl-1,3-propanediol, 5-norbornene-2,2-dimethylol, 2,3-norbornene diol, oxa-alkanediols, pentaerythritol, polyethylene glycol, propane-3-diol, 1,2-propanediol (also called 1,2-propyleneglycol), triethyleneglycol, trimethylolpropane, tripentaerythritol, 2,2,4-trimethyl-1,3-pentanediol, and 2,2-bis(p-hydroxycyclohexyl)-propane. More preferably, the polyol is selected from the group consisting of 1,2-propanediol (1,2-propylene glycol), dipropylene glycol, and cyclohexane-1,2-diol. Still more preferably, the polyol is selected from 1,2-propanediol (1,2-propylene glycol) and dipropylene glycol. It is particularly preferred that the polyol is 1,2-propanediol (1,2-propylene glycol), dipropylene glycol or a combination thereof. Most preferably, the polyol is 1,2-propanediol (1,2-propylene glycol).

In another aspect of the invention, the mixture further comprises a monofunctional alcohol, such as in amounts from about 0.01% to about 10%, more preferably from about 0.01% to about 2%, all by weight of the UPR component. Exemplary monofunctional alcohols include benzyl alcohol, cyclohexanol, 2-ethyhexyl alcohol, 2-cyclohexyl ethanol, and lauryl alcohol.

In a further aspect of the invention, the mixture comprises a diol selected from the group consisting of butane-1,4-diol, 2-butyl-2-ethyl-1,3-propanediol (BEPD), 1,3-butylene glycol, cyclohexane-1,2-diol, cyclohexane dimethanol, diethylenglycol, 2,2-dimethyl-1,4-butanediol, 2,2-dimethylheptanediol, 2,2-dimethyloctanediol, 2,2-dimethylpropane-1,3-diol, dipentaerythritol, dipropylene glycol, di-trimethylolpropane, hexane-1,6-diol, 2-methyl-1,3-propanediol, 5-norbornene-2,2-dimethylol, 2,3-norbornene diol, oxa-alkanediols, pentaerythritol, polyethylene glycol, propane-3-diol, 1,2-propanediol (also called 1,2-propyleneglycol), triethyleneglycol, trimethylolpropane, tripentaerythritol, 2,2,4-trimethyl-1,3-pentanediol, and 2,2-bis(p-hydroxycyclohexyl)-propane, and a carboxylic acid, a carboxylic acid ester and/or a carboxylic acid anhydride. More preferably, the mixture comprises 1,2-propanediol (also called 1,2-propyleneglycol), dipropylene glycol or a combination thereof as a diol, and a carboxylic acid, a carboxylic acid ester and/or a carboxylic acid anhydride. Most preferably, the mixture comprises 1,2-propanediol (1,2-propylene glycol), and a carboxylic acid, a carboxylic acid ester and/or a carboxylic acid anhydride.

The UPR may comprise a condensation product of one of the above mentioned exemplary polycarboxylic acids, esters and/or anhydrides thereof with one of the above mentioned exemplary diols. Preferably, the UPR is a condensation product of maleic anhydride and 1,2-propylene glycol. More preferably, the UPR is a condensation product of maleic anhydride and 1,2-propylene glycol in a weight ratio of about (1±0.9):1, preferably about (1±0.5):1, more preferably about (1±0.3):1, even more preferably about (1±0.1):1, and most preferably about 1:1. For example, a UPR based on maleic anhydride and 1,2-propylene glycol is available from Ashland Inc. (Dublin, Ohio, U.S.A) under the trade name AROPOL® D 1691.

The UPR also may comprise a condensation product of one or more of the above mentioned exemplary polycarboxylic acids, esters and/or anhydrides thereof with one or more of the above mentioned exemplary diols. Preferably, the UPR is a condensation product of one or more of the above mentioned exemplary polycarboxylic acids, esters and/or anhydrides thereof with one or more of the above mentioned exemplary diols. More preferably, the UPR is a condensation product of a blend of one of the above mentioned exemplary polycarboxylic acids and one of the above mentioned exemplary polycarboxylic acid anhydrides with a blend of two of the above mentioned exemplary diols. Still more preferably, the UPR is a condensation product of a blend of one of the above mentioned exemplary aromatic polycarboxylic acids and one of the above mentioned exemplary unsaturated polycarboxylic acid anhydrides with a blend of two of the above mentioned exemplary diols. Yet more preferably, the UPR is a condensation product of a blend of isophthalic acid and maleic anhydride with a blend of 1,2-propane diol and dipropylene glycol. For example, a UPR based on a blend of isophthalic acid and maleic anhydride and a blend of 1,2-propane diol and dipropylene glycol is available from Ashland Inc. (Dublin, Ohio, U.S.A) under the trade name AROPOL® K 530.

In a particularly preferred embodiment, the unsaturated polyester resin component is a reaction product of a mixture comprising at least 1, 2 or 3 diols selected from the group consisting of propylene glycol, dipropylene glycol, ethylene glycol, and diethylene glycol; and at least 1, 2, 3 or 4 acids selected from the group consisting of maleic acid, isophthalic acid, phthalic acid, and adipic acid, or their acid anhydrides.

Combinations of two or more UPRs may be used in the resin component. Further, the UPR may be modified, for example, a UPR made by reacting an oligoester having a weight average molecular weight of about 200 to about 4,000 with a diisocyanate and a hydroxyalkyl(meth)acrylate to provide a urethane acrylate having terminal vinyl groups.

The resin may be a VER and/or an epoxy resin. Examples of acceptable vinyl ester resins include the DERAKANE® vinyl ester resin products available though Ashland Inc. (Dublin, Ohio, U.S.A). Other types of vinyl esters resin components include those based on cycloaliphatic and/or linear aliphatic diepoxides. Examples of cycloaliphatic vinyl esters include those prepared using hydrogenated bisphenol A and cyclohexane. Examples of linear aliphatic vinyl esters include those prepared from neopentyl, propylene, dipropylene, polypropylene, polyethylene, and diethylene glycol diepoxides.

The resin will typically comprise a promoter. Cobalt salts are an example of a promoter that can be used with the UPR. However, in embodiments of the invention composition is cobalt free. The cobalt free formulations will also not contain additives typically used with cobalt salts in resin systems, such as dimethylaniline (DMA) or diethylaniline (DEA).

Metal catalysts useful in the resin formulation typically comprise zinc or copper, preferably in form of a zinc salt or a copper salt. Zinc salts of carboxylic acids are particularly useful for the invention, such as zinc salts of C₁-₂₀ carboxylic acids and polycarboxylic acids, preferably zinc salts of C₆-₁₂ carboxylic acid and polycarboxylic acids, including zinc acetate, zinc propionate, zinc butyrate, zinc pentanoate, zinc hexanoate, zinc heptanoate, zinc 2-ethyl hexanoate, zinc octanoate, zinc nonanoate, zinc decanoate, zinc neodecanoate, zinc undecanoate, zinc undecenylate, zinc dodecanoate, zinc palmitate, zinc stearate, zinc oxalate, and zinc naphthenate. Other zinc salts useful herein include the zinc salts of amino acids such as zinc alanine, zinc methionine, zinc glycine, zinc asparagine, zinc aspartine, zinc serine, and the like. Other zinc salts include zinc citrate, zinc maleate, zinc benzoate, zinc acetylacetonate, and the like. Other zinc salts include zinc chloride, zinc sulfate, zinc phosphate, and zinc bromide. The zinc chalcogens and zinc oxide can also be used. Zinc octoanate (zinc octoate) is particularly preferred. Copper salts useful in the invention are typically copper (I) salts or copper (II) salts, such as copper acetate, copper octanoate, copper naphthenate, copper acetylacetonate, copper chloride or copper oxide.

The amount of catalyst may be in the range of from about 0.001% to about 1%, more preferably about 0.01% to about 0.1%, by weight of the UPR formulation. In certain embodiments, however, the amount of metal catalyst will be, based on the weight of the UPR formulation, about 0.20±0.15%, more preferably about 0.20±0.10%, most preferably about 0.20±0.05%. Based on the weight of the flooring material composition, the content of the catalyst is within the range of from about 0.0001% to about 0.1%, more preferably about 0.001% to about 0.01%. Preferably, the content of the metal catalyst, based on the weight of the flooring component or engineered stone slab is within the range of about 0.020±0.015%, more preferably about 0.020±0.010%, most preferably about 0.020±0.005%.

The resin formulation may further comprise quaternary ammonium salt such as benzyl-N,N,N-trialkylammonium salt or N,N,N,N-tetraalkylammonium salt. Benzyl-N,N,N-trimethylammonium salts such as benzyl-N,N,N-trimethylammonium chloride; and benz-alkonium chlorides such as benzyl-N,N,N—C₂₋₂₀-alkyl-dimethyl-ammonium salts, e.g. benzyl-N,N,N—C₂₋₂₀-alkyl-dimethyl-ammonium chloride, and N,N,N,N-tetraalkylammonium salt, e.g. N,N—C₂₋₂₀-dialkyl-N,N-dimethyl ammonium salts, and the mixtures thereof may be used. The content of the quaternary ammonium salt, by weight of the resin formulation, is preferably within the range of from about 0.001% to about 5%, more preferably about 0.01% to about 0.5%. Preferably, the content of the quaternary ammonium salt, based on the total weight of the resin formulation is within the range of about 0.20±0.15%, more preferably about 0.20±0.10%, most preferably about 0.20±0.05%. The content of the quaternary ammonium salt, based on the total weight of the flooring material composition, is preferably within the range of from about 0.0001% to about 0.5%, more preferably about 0.001% to about 0.05%. Preferably, the content of the quaternary ammonium salt, relative to the total weight of the flooring material composition, is within the range of about 0.020±0.015%, more preferably about 0.020±0.010%, most preferably about 0.020±0.005%. One skilled in the art will recognize that the quaternary ammonium salt in the resin formulation is separate and independent and typically different from the particles, preferably encapsulated particles, comprising ammonium quaternary salts in the flooring material composition. The differences may be the chemical nature and/or the physical state. For example, the quaternary ammonium salt in the resin formulation may be dissolved, i.e. present in liquid form, whereas the (B) particles comprising ammonium quaternary salts are solid.

The resin formulation may further comprise reactive diluents, such as those selected from the group consisting of styrene, substituted styrene, nono-, di- and polyfunctional esters of monofunctional acids with alcohols or polyols, mono-, di- and polyfunctional esters of unsaturated monofunctional alcohols with carboxylic acids or their derivatives.

The resin formulation may also comprise one or more additives. These include those selected from the group consisting of accelerators, co-promoters, dispersing agents, UV absorbers, stabilizers, inhibitors and rheology modifiers. Suitable additives are known to the skilled person.

The total content of optional additives, by total weight of the resin formulation, is preferably within the range of from about 0.001% to about 10%, more preferably about 0.01% to about 5%. The total content of optional additives, by the total weight of the flooring material composition, is preferably within the range of from about 0.0001% to about 1%, more preferably about 0.001% to about 0.5%.

Inhibitors may be used to lengthen the gel time (pot life), particularly when very long gel times are required or when resin is curing quickly due to high temperatures. Some common inhibitors that may incorporated into the resin formulation include tertiary butyl catechol, hydroquinone, and toluhydroquinone, and the like, and combinations thereof.

Fillers may useful in the resin formulation to provide specific functionality. The resin formulation may comprise fillers selected from the group consisting of alumina trihydrate, calcium carbonate, talc, kaolin clays, silicon carbide, aluminum oxide stem and the like and combinations thereof.

Other additives that may be included in the resin formulation are dispersing agents, which are chemicals that aid in the dispersion of solid components in the resin formulation, i.e. enhance the dispersion of solid components in the UPR. Useful dispersing agents include but are not limited to copolymers comprising acidic functional groups like BYK®-W 996 available for Byk USA, Inc., Wallingford, Conn., U.S.A. (“Byk”), unsaturated polycarboxylic acid polymer comprising polysiloxane copolymer, like BYK®-W 995 available from Byk, copolymer comprising acidic functional groups, like BYK®-W 9011 available from Byk, copolymer comprising acidic functional groups, like BYK®-W 969 available from Byk and alkylol ammonium salt of an acidic polyester. Combinations of dispersing agents may be used.

The resin formulation may further comprise co-promoters to enhance cure. Co-promoters useful in the invention include 2,4-petendione, 2-acetylbutyrolactone, ethyl acetoacetonate, n,n-diethyl acetoacetamide and the like, and combinations thereof.

Coupling agents may also be included in the resin formulation. These includes silanes, such as 3-triethoxy-silyl-propyl-methacrylate and silane modified polyethylene glycol. Another additives useful in the resin formulation are rheology modifiers, including fumed silica, organic clay and the like, and combinations thereof. In addition, the resin formulation may comprise synergist agents, including polysorbate 20 (Tween 20), polyhydroxycarboxylic acid esters, such as BYK®-R605 and R606 available from Byk and the like, and combinations thereof.

In a particular embodiment of the invention, the resin formulation comprises:
(i) a UPR component; preferably a reaction product of a mixture comprising at least 1, 2 or 3 diols selected from the group consisting of propylene glycol, dipropylene glycol, ethylene glycol, and diethylene glycol; and at least 1, 2, 3 or 4 acids selected from the group consisting of maleic acid, isopthalic acid, phthalic acid, and adipic acid, or their acid anhydrides;
(ii) a metal catalyst comprising zinc or copper and being capable of catalyzing curing of said UPR component; preferably a zinc salt of a carboxylic acid, more preferably a zinc salt of a C₁-₂₀ carboxylic acid, still more preferably a zinc salt of a C₆-₁₂ carboxylic acid, most preferably zinc octanoate;
(iii) a benzyl-N,N,N-trialkylammonium salt and/or a N,N,N,N-tetraalkylammonium salt; preferably a benzyl-N,N,N—C₂₋₂₀-alkyl-dimethyl-ammonium salt or a benzyl-N,N,N-trimethylammonium salt or a or a N,N—C₂₋₂₀-dialkyl-N,N-dimethylammonium salt;
(iv) optionally, reactive diluent; and
(v) optionally, one or more additives selected from the group consisting of accelerators, co-promoters, dispersing agents, UV absorbers, stabilizers and rheology modifiers.

In this embodiment, the content of the metal catalyst, preferably zinc octanoate, based on the total weight of the resin formulation, is typically within the range of from about 0.001% to about 1%, more preferably about 0.01% to about 0.1%. Preferably, the content of the metal catalyst, preferably zinc octanoate, based on the total weight of the resin formulation, is within the range of about 0.20±0.15%, more preferably about 0.20±0.10%, most preferably about 0.20±0.05%. The content of the benzyl-N,N,N-trialkylammonium salt, preferably benzyl-N,N,N—C₂₋₂₀-alkyl-dimethyl-ammonium salt or benzyl-N,N,N-trimethylammonium salt or N,N,N,N-tetraalkylammonium salt, relative to the total weight of the resin formulation, is preferably within the range of from about 0.001% to about 5%, more preferably about 0.01% to about 0.5%.

Preferably, the content of the benzyl-N,N,N-trialkylammonium salt and/or a N,N,N,N-tetraalkylammonium salt, preferably benzyl-N,N,N-trialkylammonium salt, benzyl-N,N,N—C₂₋₂₀-alkyl-dimethyl-ammonium salt, benzyl-N,N,N-trimethylammonium salt, or N,N—C₂₋₂₀-dialkyl-N,N-dimethylammonium salt by the total weight of the resin formulation, is within the range of about 0.20±0.15%, more preferably about 0.20±0.10%, most preferably about 0.20±0.05%.

The resin formulation described herein is combined with other materials to make the flooring material composition. Generally, the flooring material composition will comprise up to about 25% resin formulation based in the weight of the flooring material composition. Typically, the flooring material composition will comprise about 5% to about 20% resin formulation, such as about 7% to about 15% resin formulation, all based on the weight of the flooring material composition.

The flooring material composition comprises particles, preferably encapsulated particles, comprising ammonium quaternary salts. These are present in an effective amount to provide flooring materials comprising, and made with, the composition to have antistatic properties, that is the flooring materials have electric resistivity values within the dissipative established zone.

Preferably, the ammonium quaternary salt that is comprised in the (B) particles differs from the (iii) quaternary ammonium salt that is comprised in the (A) unsaturated polyester resin formulation, although it is also encompassed within the invention that the ammonium quaternary salt and the quaternary ammonium salt are identical. The ammonium quaternary salt that is comprised in the (B) particles is present in solid form, whereas the (iii) quaternary ammonium salt that is comprised in the (A) unsaturated polyester resin formulation is preferably present in liquid form.

In a preferred embodiment, the ammonium quaternary salt that is comprised in the (B) particles, which are preferably encapsulated, is a N,N,N,N-tetraalkylammonium salt, a N-phenyl-N,N,N-trialkylammonium, a N-benzyl-N,N,N-trialkylammonium salt, a N,N-diphenyl-N,N-dialkylammonium salt, a N,N-dibenzyl-N,N-dialkylammonium salt, or a N-phenyl-N-benzyl-N,N-dialkylammonium salt.

Examples of ammonium quaternary salts include but are not limited to benzyl-N,N,N-trimethylammonium salts such as benzyl-N,N,N-trimethylammonium chloride; and benz-alkonium chlorides such as benzyl-N,N,N—C₁₋₂₀-alkyl-dimethyl-ammonium salts, e.g. benzyl-N,N,N—C₁₋₂₀-alkyl-dimethyl-ammonium chloride, and N,N,N,N-tetraalkylammonium salt, e.g. N,N—C₁₋₂₀-dialkyl-N,N-dimethyl ammonium salts, and the mixtures thereof. Further examples include but are not limited to N-(3-chloro-2-hydroxypropyl)-trimethylammonium chloride, tetramethylammonium chloride, and dimethylphenylbenzylammonium chloride. Additional examples include but are not limited to methyltrihexylammonium chloride, methyltrioctyl-ammonium chloride, methyltridecylammonium chloride, methyltridodecylammonium chloride, dioctyldimethylammonium bromide, didecyldimethylammonium bromide, di-dodecyl dimethyl ammonium bromide, tetrahexylammonium bromide, tetraoctylammonium bromide, tetradecylammonium bromide, tetra-dodecylammonium bromide, 1-dodecyl-2-methyl-3-benzylimidazolium chloride, 1-tetradecyl-2-methyl-3-benzylimidazolium chloride, 1-hexa-decyl-2-methyl-3-benzylimidazolium chloride, 1-octadecyl-2-methyl-3-benzyl-imidazolium chloride, 1-hexyl-3-methylimidazolium chloride, 1-octyl-3-methylimidazolium chloride, methylpyridinium chloride, ethylpyridinium chloride, propylpyridinium chloride, butylpyridinium chloride, hexylpyridinium chloride, octylpyridinium chloride, decylpyridinium chloride, dodecylpyridinium chloride and hexadodecylpyridinium chloride.

The particles, preferably nanoparticles, comprising ammonium quaternary salt according to the invention are preferably encapsulated.

In preferred embodiments, the particles, preferably nanoparticles are encapsulated by an encapsulating material which is preferably a synthetic polymer, more preferably selected from the group consisting of polyurethane, polyurea, polyamide, polyester, polycarbonate, a urea/formaldehyde resin, a melamine resin, polystyrene, a styrene/methacrylate copolymer, a styrene/acrylate copolymer and a mixture of any of the foregoing. Preferably, the encapsulating material is selected from the group consisting of polyurethane, polyurea, polyamide, polyester, or polycarbonate.

The particles comprising ammonium quaternary salt are preferably nanoparticles. When these nanoparticles are encapsulated, the overall encapsulated particles comprising ammonium quaternary salt and encapsulating material are typically larger than the cores thereof which comprise the ammonium quaternary salt and which are surrounded by the encapsulating material. Thus, these particles may be regarded as “encapsulated nanoparticles”, although their overall size, due to the enlargement by the encapsulating material, may be in the range of microparticles (microencapsulated nanoparticles).

Microencapsulated materials including microencapsulated microparticles and microencapsulated nanoparticles are commercially available and methods suitable for their manufacture are known to those skilled in the art. In general, encapsulation (e.g. microencapsulation) of microparticles and nanoparticles is a process in which tiny particles or droplets are surrounded by a coating (encapsulating material) to give small capsules of many useful properties. In a relatively simple form, a microcapsule or a nanocapsule is a small sphere with a uniform wall around it.

The technique of encapsulation depends on the physical and chemical properties of the material to be encapsulated. The core may be a crystal, a jagged adsorbent particle, an emulsion, a Pickering emulsion, a suspension of solids, a suspension of smaller microcapsules or nanoparticles, and the like. The particle (e.g. microcapsule or nanocapsule) even may have multiple walls. Techniques to manufacture encapsulated particles include but are not limited to physical methods such as pan coating, air-suspension coating, centrifugal extrusion, vibrational nozzle, or spray-drying; physico-chemical methods such as ionotropic gelation, or coacervation-phase separation; and chemical methods such as interfacial polycondensation, interfacial cross-linking, in-situ polymerization, or matrix polymerization.

Generally, the flooring materials will have electric resistivity values of, about 10⁵ to about 10¹¹Ω, preferably, in the range of about 10⁷Ω to about 10¹⁰Ω for 100V and 500V voltage levels.

Typically, the flooring material composition will comprise up to about 3% of the particles, preferably encapsulated particles, such as about 0.05% to about 2%, like about 0.1% to about 1.0% all based on the weight of the flooring material composition.

The particles according to the invention that comprise the ammonium quaternary salt may be microparticles or nanoparticles. The particles, preferably encapsulated particles, preferably have an (overall) average particle size of about 10 μm to about 250 μm, such as about 75 μm to about 175 μm. Thus, with regard to their overall size, the particles according to the invention are preferably microparticles. However, when the particles are encapsulated (encapsulated particles), the particles preferably comprise a core that is surrounded by an encapsulating material. Preferably, said core comprises the majority of or the total amount of the ammonium quaternary salt and is substantially smaller than the overall size of the particles including the encapsulating material. In a preferred embodiment, the cores have an average particle size of about 1.0 nm to about 10,000 nm, more preferably about 10 nm to about 750 nm (nanoparticles). One particles may comprise a single or a plurality of cores. Thus, with regard to the core(s), the encapsulated particles according to the invention are preferably nanoparticles (encapsulated nanoparticles). When the cores of the encapsulated particles that comprises the majority of or the total amount of the ammonium quaternary salt are in the nanometer range (preferably about 10 nm to about 750 nm) and due to the enlargement by the encapsulating material the overall size of the encapsulated particles is in the micrometer range (preferably about 10 μm to about 250 μm), this may be described by the term “microencapsulated nanoparticles”.

Encapsulated nanoparticles available under the trade name avanSTATIC from AVANZARE Innovacion Tecnologica S.L., Spain may be used in the invention.

The flooring material composition further comprises inorganic particulate material. Preferably, the inorganic particulate material that is contained in the flooring material composition according to the invention comprises quartz, in form of quartz aggregate and/or quartz filler. In a typical embodiment, the flooring material composition will comprise, based on the weight of the flooring material composition, about 15% to about 35%, such as about 20% to about 30% quartz filler, such as those having a particle size of up to about 45 μm; about 25% to about 75%, such as about 40% to about 60%, quartz aggregates having a particle size of up to about 0.3 μm, like about 0.1 μm to about 0.3 μm and about 5% to about 30%, such as about 10% to about 30%, quartz aggregates having a particle size of greater than about 0.3 μm, like greater than about 0.3 μm to about 0.6 μm.

Preferably, the largest particle size is 1.2 mm, i.e. the inorganic particulate material preferably does not contain a significant amount of particles larger than 1.2 mm. Preferably, the average particle size of the inorganic particulate material is within the range of from about 10 μm to about 50 μm, about 20 μm to about 60 μm, about 30 μm to about 70 μm, about 10 μm to about 30 μm, about 20 μm to about 40 μm, about 30 μm to about 50 μm, about 40 μm to about 60 μm, or about 50 μm to about 70 μm.

In certain embodiments, the aggregate is a fine aggregate and/or a coarse aggregate. Fine aggregate is typically a material that almost entirely passes through a Number 4 sieve (ASTM C 125 and ASTM C 33), such as silica sand. Preferably, a coarse aggregate is a material that is predominantly retained on a Number 4 sieve (ASTM C 125 and ASTM C 33), such as silica, quartz, crushed marble, glass spheres, granite, limestone, calcite, feldspar, alluvial sands, sands or any other durable aggregate, and mixtures thereof.

As such, the term “aggregate” is used broadly to refer to a number of different types of both coarse and fine particulate material, including, but are not limited to, sand, gravel, crushed stone, slag, and recycled concrete. The amount and nature of the aggregate may vary widely. In some embodiments, the amount of aggregate may range from about 10 wt.-% to about 90 wt.-%, relative to the total content of inorganic particulate material.

Embodiments concerning the particle size distribution of the inorganic particulate material are summarized as embodiments A¹ to A⁸ in the table below (all values in wt.-%):

| particle | | | | | | | | |
|---|---|---|---|---|---|---|---|---|
| size | A¹ | A² | A³ | A⁴ | A⁵ | A⁶ | A⁷ | A⁸ |
| <0.1 | <5.0 | <4.0 | <3.0 | <2.5 | <2.0 | <1.5 | <1.0 | <0.5 |
| μm | | | | | | | | |
| 0.1-0.3 | 15-95 | 20-90 | 25-85 | 30-80 | 35-75 | 40-70 | 45-65 | 50-60 |
| μm | | | | | | | | |
| 0.3-0.6 | 1-35 | 3-32 | 5-30 | 7-28 | 9-26 | 11-24 | 13-22 | 15-20 |
| μm | | | | | | | | |
| >0.6 | 4-51 | 7-48 | 10-45 | 13-42 | 16-39 | 19-36 | 22-33 | 25-30 |
| μm | | | | | | | | |

Preferred embodiments concerning the particle size distribution of the inorganic particulate material are summarized as embodiments A⁹ to A¹⁶ in the table below (all values in wt.-%):

| particle | | | | | | | | |
|---|---|---|---|---|---|---|---|---|
| size | A⁹ | A¹⁰ | A¹¹ | A¹² | A¹³ | A¹⁴ | A¹⁵ | A¹⁶ |
| <100 | 10-50 | 12-48 | 15-45 | 17-43 | 19-41 | 21-39 | 23-37 | 25-35 |
| μm | | | | | | | | |
| 100-300 | 5-45 | 7-43 | 10-40 | 12-38 | 14-36 | 16-34 | 18-32 | 20-30 |
| μm | | | | | | | | |
| 300-600 | 15-55 | 17-52 | 20-50 | 22-48 | 24-46 | 26-44 | 28-42 | 30-40 |
| μm | | | | | | | | |

In certain embodiments, the inorganic particulate material has a particle size distribution such that
about 30% to about 70% of the particles, by weight of the flooring material composition, have a particle size within the range of from about 0.1 μm to about 0.3 μm;
about 5% to about 30% of the particles, by weight of the flooring material composition, have a particle size within the range of from about 0.3 μm to about 0.6 μm; and
about 10% to about 40% of the particles, by weight of the flooring material composition, have a particle size within the range of from about 20 μm to about 60 μm.

Suitable methods for determining the average particle size and particle size distribution of an inorganic particulate material are known to the skilled person such as laser light scattering according to ASTM C1070-01(2014) or electric sensing zone technique according to ASTM C690-09.

Preferably, the content of the inorganic filler material is about 70% to about 99.9%, more preferably about 80% to about 95%, by total weight of the flooring material composition. Preferably, the content of the inorganic filler material is within the range of about 90±7%, more preferably about 90±6%, still more preferably about 90±5%, yet more preferably about 90±4%, even more preferably about 90±3%, most preferably about 90±2%, and in particular about 90±1%, by weight of the flooring material composition.

The flooring material composition may, optionally, further comprise one or more pigments as an additive. Any organic or inorganic pigments conventionally used in making flooring materials may be use in the invention. The pigment provides desired coloring to the flooring material, and such pigments can be used in the flooring material compositions having antistatic properties to provide the same color as conventional flooring materials, that is flooring materials used in conventional non-antistatic flooring applications. Pigments useful with the flooring material compositions described herein include, but are not limited to, those selected from the group consisting of titanium dioxide, Special Black 100 (available from Orion Carbons S.A., Luxembourg), Monastral Blue FBN (available from Heubach GmbH, Langelsheim, Germany), Sunfast Blue 248 3650 (available from Sun Chemical Corporation, Parsippany, N.J., U.S.A.), Chrome Oxide Green GN (available from Lanxess, Cologne, Germany), RMP HEL GR K8730 RA (available from BASF, Parsippany, N.J. U.S.A.), Palioltol Yellow L0962HD (available from BASF, Parsippany, N.J., U.S.A.), RMP BAYFERR 3920 RA (available from Lanxess, Cologne, Germany), Lysopac Yellow 7010 C (available from Capelle Pigments NV, Menen, Belgium), RMP NPROT F2RK70 RA (available from Clariant International Ltd, Muttenz, Switzerland), Cobalt Blue 34L86 (available from Johnson Matthey, London, England), Cobalt Blue 34L2001 (available from Johnson Matthey, London, England), and the like, and combinations thereof.

Curing of the flooring material composition according to the invention may be induced by including an initiator, such as a radical initiator like peroxides. Thus, the flooring material composition may comprise one or more peroxides. The initiator generates free radicals reacting with the ethylenic unsaturation of the UPR, thereby causing cross-linking of the polymer network. Preferred peroxides are organic peroxides that work together with the metal catalyst (promoters) to initiate the chemical reaction that causes a resin to gel and harden. The amount of time from which the peroxide is added until the resin begins to gel is referred to as the “gel time” or “pot life”. Peroxide and metal catalyst levels can be adjusted, to a certain extent, to shorten or lengthen the gel time and accommodate both high and low temperatures. If a longer gel time is required, inhibitors can be added.

The peroxide component may be hydroperoxide and/or an organic peroxide, like an organic hydroperoxide. Preferably, the peroxide component is selected from the group consisting of methyl ethyl ketone peroxide (MEKP), methyl isobutyl ketone peroxide (MIKP), benzoyl peroxide (BPO), tert-butyl peroxibenzoate (TBPB), cumene hydroperoxide (CHP), and mixtures thereof. Cumene hydroperoxide and/or methyl isobutyl ketone peroxide are particularly preferred. It has been surprisingly found that cumene hydroperoxide and/or methyl isobutyl ketone peroxide as peroxide component, preferably in combination with zinc salts or copper salts as metal catalysts (promoters), has particular advantages with respect to cure, pot life, appearance and mechanical properties, allowing for the complete omission of cobalt salts.

Preferably, the content of the peroxide component, preferably cumene hydroperoxide and/or methyl isobutyl ketone peroxide, is about 0.01% to about 5.0%, more preferably about 0.05% to about 4.0%, based on the total weight of the resin formulation. Preferably, the content of the peroxide component, preferably cumene hydroperoxide, by total weight of the flooring material composition is within the range of about 2.0±1.5%, more preferably about 2.0±1.0%, most preferably about 2.0±0.5%. Typically, the content of the peroxide component, preferably cumene hydroperoxide and/or methyl isobutyl ketone peroxide, is about 0.001% to about 0.1%, more preferably about 0.005% to about 0.05%, based on the total weight of the flooring material composition. Preferably, the content of the peroxide component, preferably cumene hydroperoxide, relative to the total weight of the flooring material composition, is within the range of about 0.20±0.15%, more preferably about 0.20±0.10%, most preferably about 0.20±0.05%.

Preferred embodiments concerning the nature of metal catalyst, ammonium salt and peroxide are summarized as embodiments B¹ to B²⁸ in the table below:

| | metal catalyst | ammonium salt | peroxide |
|---|---|---|---|
| B¹ | zinc salt of | benzyl-N,N,N-C₂₋₂₀-alkyl- | organic peroxide |
| | carboxylic acid | dimethyl-ammonium salts | |
| B² | zinc salt of | benzyl-N,N,N-trimethyl- | organic peroxide |
| | carboxylic acid | ammonium salts | |
| B³ | zinc salt of | benzyl-N,N,N-C₂₋₂₀-alkyl- | hydroperoxide |
| | C₁-₂₀ carboxylic | dimethyl-ammonium salts | |
| | acid | | |
| B⁴ | zinc salt of | benzyl-N,N,N-trimethyl- | hydroperoxide |
| | C₁-₂₀ carboxylic | ammonium salts | |
| | acid | | |
| B⁵ | zinc salt of | benzyl-N,N,N-C₂₋₂₀-alkyl- | organic hydroperoxide |
| | C₆-₁₂ carboxylic | dimethyl-ammonium salts | |
| | acid | | |
| B₆ | zinc salt of | benzyl-N,N,N-trimethyl- | organic hydroperoxide |
| | C₆-₁₂ carboxylic | ammonium salts | |
| | acid | | |
| B₇ | zinc octanoate | benzyl-N,N,N-C₂₋₂₀-alkyl- | cumene hydroperoxide |
| | | dimethyl-ammonium salts | |
| B₈ | zinc octanoate | benzyl-N,N,N-trimethyl- | cumene hydroperoxide |
| | | ammonium salts | |
| B₉ | zinc salt of | benzyl-N,N,N-C₂₋₂₀-alkyl- | methyl isobutyl ketone |
| | C1-20 | dimethyl-ammonium salts | peroxide |
| | carboxylic acid | | |
| B₁₀ | zinc salt of | benzyl-N,N,N-trimethyl- | methyl isobutyl ketone |
| | C1-20 | ammonium salts | peroxide |
| | carboxylic acid | | |
| B₁₁ | zinc salt of | benzyl-N,N,N-C₂₋₂₀-alkyl- | methyl isobutyl ketone |
| | C6-12 | dimethyl-ammonium salts | peroxide |
| | carboxylic acid | | |
| B₁₂ | zinc salt of | benzyl-N,N,N-trimethyl- | methyl isobutyl ketone |
| | C6-12 | ammonium salts | peroxide |
| | carboxylic acid | | |
| B₁₃ | zinc octanoate | benzyl-N,N,N-C₂₋₂₀-alkyl- | methyl isobutyl ketone |
| | | dimethyl-ammonium salts | peroxide |
| B₁₄ | zinc octanoate | benzyl-N,N,N-trimethyl- | methyl isobutyl ketone |
| | | ammonium salts | peroxide |
| B₁₅ | zinc salt of | N,N,N,N-tetra- | organic peroxide |
| | carboxylic acid | alkylammonium salts | |
| B₁₆ | zinc salt of | N,N-C₂₋₂₀-dialkyldimethyl- | organic peroxide |
| | carboxylic acid | ammonium salts | |
| B₁₇ | zinc salt of | N,N,N,N-tetraalkyl- | hydroperoxide |
| | C1-20 | ammonium salts | |
| | carboxylic acid | | |
| B₁₈ | zinc salt of | N,N-C₂₋₂₀-dialkyldimethyl- | hydroperoxide |
| | C1-20 | ammonium salts | |
| | carboxylic acid | | |
| B₁₉ | zinc salt of | N,N,N,N-tetraalkyl- | organic hydroperoxide |
| | C6-12 | ammonium salts | |
| | carboxylic acid | | |
| B₂₀ | zinc salt of | N,N-C₂₋₂₀-dialkyldimethyl- | organic hydroperoxide |
| | C6-12 | ammonium salts | |
| | carboxylic acid | | |
| B₂₁ | zinc octanoate | N,N,N,N-tetraalkyl- | cumene hydroperoxide |
| | | ammonium salts | |
| B₂₂ | zinc octanoate | N,N-C₂₋₂₀-dialkyldimethyl- | cumene hydroperoxide |
| | | ammonium salts | |
| B₂₃ | zinc salt of | N,N,N,N-tetraalkyl- | methyl isobutyl ketone |
| | C1-20 | ammonium salts | peroxide |
| | carboxylic acid | | |
| B₂₄ | zinc salt of | N,N-C₂₋₂₀-dialkyldimethyl- | methyl isobutyl ketone |
| | C1-20 | ammonium salts | peroxide |
| | carboxylic acid | | |
| B₂₅ | zinc salt of | N,N,N,N-tetraalkyl- | methyl isobutyl ketone |
| | C6-12 | ammonium salts | peroxide |
| | carboxylic acid | | |
| B₂₆ | zinc salt of | N,N-C₂₋₂₀-dialkyldimethyl- | methyl isobutyl ketone |
| | C6-12 | ammonium salts | peroxide |
| | carboxylic acid | | |
| B₂₇ | zinc octanoate | N,N,N,N-tetraalkyl- | methyl isobutyl ketone |
| | | ammonium salts | peroxide |
| B₂₈ | zinc octanoate | N,N-C₂₋₂₀-dialkyldimethyl- | methyl isobutyl ketone |
| | | ammonium salts | peroxide |

The flooring material composition according to the invention has a pot life of at least about 30 minutes, more preferably at least about 1 hour, still more preferably at least about 1.5 hours and most preferably at least about 2 hours. Preferably, at 40° C. the pot life of the flooring composition according to the invention, measured after mixing the components is within the range of about 4.3±3.5 hours, more preferably about 4.3±3.0 hours, still more preferably about 4.3±2.5 hours, yet more preferably about 4.3±2.0 hours, even more preferably about 4.3±1.5 hours, most preferably about 4.3±1.0 hours, and in particular about 4.3±0.5 hours.

Typically, the flooring material composition has a polymerization time at 110° C. of at least about 30 minutes, more preferably at least about 1 hour. Preferably, at 110° C. the polymerization time of the flooring composition according to the invention, is within the range of about 60±35 minutes, more preferably about 60±30 minutes, still more preferably about 60±25 minutes, yet more preferably about 60±20 minutes, even more preferably about 60±15 minutes, most preferably about 60±10 minutes, and in particular about 60±5 minutes.

The flooring material composition is made into flooring material by processing the flooring material composition into a formable article and curing the resin in the composition. For example, the typical Brenton manufacturing process can be used. The flooring material composition may be made into an engineered stone slab which is then transformed into pieces of flooring material.

A method for the preparation of flooring material comprises the steps of
(a) preparing a formable composition by mixing
   (A) the resin formulation as defined above;
   (B) the particles, preferably encapsulated particles, comprising ammonium quaternary salts as defined above;
   (C) an inorganic particulate material as defined above;
   (D) a peroxide component as defined above; and
   (E) optionally one or more pigments;
(b) forming the composition prepared in step (A) into a desired shape;
(c) allowing the composition formed in step (b) to cure to obtain flooring material.

The flooring material can be cut into desired sizes and shapes, such as into tiles or larger rolled flooring materials. Reactive diluents may also be incorporated into step (a).

In another aspect of the invention, engineered stone is obtained from the flooring material composition which can then be made into flooring material. In accordance with this embodiment, a process for making engineered stone comprises:
(a) preparing a formable composition by mixing
   (A) the resin formulation as defined above;
   (B) the particles, preferably encapsulated particles, comprising ammonium quaternary salts as defined above;
   (C) an inorganic particulate material as defined above;
   (D) a peroxide component as defined above; and
   (E) optionally one or more pigments;
(b) forming the composition prepared in step (a) into a desired shape;
(c) allowing the composition formed in step (b) to cure to obtain an engineered stone slab.

The engineered stone slab may be made into flooring material by procedures that would be understood to one skilled in the art. Reactive diluents may also be incorporated into step (a).

Preferably, the flooring material or engineered stone slab typically has a flexural strength of at least about 40 MPa, more preferably at least about 45 MPa, still more preferably at least about 50 MPa, and most preferably at least about 55 MPa. Preferably, the flexural strength is within the range of about 62±35 MPa, more preferably about 62±30 MPa, still more preferably about 62±25 MPa, yet more preferably about 62±20 MPa, even more preferably about 62±15 MPa, most preferably about 62±10 MPa, and in particular about 62±5 MPa. Methods for determining the flexural strength of engineered stone are known to the skilled person, e.g. ASTM C880, which is incorporated herein by reference in its entirety.

The flooring material or engineered stone slab typically has an impact resistance of at least about 2 J/m, more preferably at least about 2.5 J/m, still more preferably at least about 3 J/m, and most preferably at least about 3.5 J/m. Preferably, the impact resistance is within the range of about 4.5±3.5 J/m, more preferably about 4.5±3.0 J/m, still more preferably about 4.5±2.5 J/m, yet more preferably about 4.5±2.0 J/m, even more preferably about 4.5±1.5 J/m, most preferably about 4.5±1.0 J/m, and in particular about 4.5±0.5 J/m. Methods for determining the impact resistance of engineered stone are known to the skilled person and are incorporated into industrial standards, such as standard EN 41617-9 which is incorporated herein by reference in its entirety.

The flooring material or engineered stone slab typically has a linear stability of at most about 50·10⁻⁶ m/m° C., more preferably at most about 45·10⁻⁶ m/m° C., still more preferably at most about 40·10⁻⁶ m/m° C., and most preferably at most about 35·10⁻⁶ m/m° C. Preferably, the linear stability is within the range of about 18±14·10⁻⁶ m/m° C., more preferably about 18±12·10⁻⁶ m/m° C., still more preferably about 18±10·10⁻⁶ m/m° C., yet more preferably about 18±8·10⁻⁶ m/m° C., even more preferably about 18±6·10⁻⁶ m/m° C., most preferably about 18±4·10⁻⁶ m/m° C., and in particular about 18±2·10⁻⁶ m/m° C. Methods for determining the linear stability of engineered stone are known to the skilled person, e.g. ASTM C179, which is incorporated herein by reference in its entirety.

Preferably, the flooring material or engineered stone slab has a vertical electrical resistivity of not more than about 1·10¹¹Ω, more preferably not more than about 110¹⁰Ω, still more preferably not more than about 1·10⁹Ω, and most preferably not more than about 5·10⁸Ω for 100V and 500V voltage levels. Preferably, the vertical electrical resistivity is within the range of from about 0.6·10⁷Ω to about 250·10⁷Ω, more preferably from about 0.7·10⁷Ω to about 150·10⁷Ω, still more preferably from about 0.8·10⁷Ω to about 125·10⁷Ω, yet more preferably from about 0.9·10⁷Ω to about 100·10⁷Ω, even more preferably from about 1·10⁷Ω to about 75·10⁷Ω, most preferably from about 2·10⁷Ω to about 50·10⁷Ω, and in particular from about 3·10⁷Ω to about 25·10⁷Ω for 100V and 500V voltage levels. Methods for determining the vertical electrical resistivity of engineered stone are known to the skilled person, e.g. UNE-EN-1081:2004, method A (R1), which is incorporated herein by reference in its entirety.

Preferably, the flooring material or engineered stone slab has a surface electrical resistivity of not more than about 1.10¹¹Ω, more preferably not more than about 1·10¹⁰Ω, still more preferably not more than about 1·10⁹Ω, and most preferably not more than about 1.5·10⁸Ω for 100V and 500V voltage levels. Preferably, the surface electrical resistivity is within the range of from about 2·10⁷Ω to about 300·10⁷Ω, more preferably from about 3·10⁷Ω to about 250·10⁷Ω, still more preferably from about 4·10⁷Ω to about 200·10⁷Ω, yet more preferably from about 5·10⁷Ω to about 150·10⁷Ω, even more preferably from about 6·10⁷Ω to about 125·10⁷Ω, most preferably from about 7·10⁷Ω to about 100·10⁷Ω, and in particular from about 8·10⁷Ω to about 85·10⁷ 5/for 100V and 500V voltage levels. Methods for determining the surface electrical resistivity of engineered stone are known to the skilled person, e.g. UNE-EN-1081:2004, method C (R3), which is incorporated herein by reference in its entirety.

The following examples further illustrate the invention but are not to be construed as limiting its scope:

### EXAMPLE 1

Tiles of three different types in accordance with the invention (size 300 mm×300 mm×10 mm) were prepared from unsaturated polyester resin (UPR), quartz, and encapsulated particles comprising ammonium quaternary salt [available under the trade name avanSTATIC from AVANZARE Innovacion].

Three samples in accordance with the invention were prepared. All samples had the following composition in common (UPR resin, filler, silica):

| | % | % | specific | | | |
|---|---|---|---|---|---|---|
| | Volume | weight | weight | weight | Volume | Mass/dm³ |
| Ingredient | [vol.-%] | [wt.-%] | [kg/dm³] | [g] | [cm³] | [kg/dm³] |
| UPR | 20.8 | 10 | 1.12 | 400 | 357 | 0.233 |
| resin | | | | | | |
| filler | 26.4 | 30 | 2.65 | 1200 | 453 | 0.699 |
| 0.1-0.3 | 30.8 | 35 | 2.65 | 1400 | 528 | 0.816 |
| mm sillica | | | | | | |
| 0.3-0.6 | 17.6 | 20 | 2.65 | 800 | 302 | 0.466 |
| mm sillica | | | | | | |
| 1-3 | 4.4 | 5 | 2.65 | 200 | 75 | 0.117 |
| mm sillica | | | | | | |
| total | 100.0 | 100.0 | | 4000 | 1716 | 2.33 |

Thus, the total weight amounted to 4000 g.

The UPR resin was in all cases the same, namely a reaction product of a mixture comprising one or more diols selected from the group consisting of propylene glycol, dipropylene glycol, ethylene glycol, and diethylene glycol; and one or more acids selected from the group consisting of maleic acid, isophthalic acid, phthalic acid, and adipic acid, or their acid anhydrides.

The following pigment composition was employed for all three samples:

| Pigments | % on resin content | resin weight | total [g] |
|---|---|---|---|
| Titan | 5.000 | 400 | 20.000 |
| Yellow 920 | 0.013 | 400 | 0.050 |
| Yellow 960 | 0.025 | 400 | 0.100 |

The differences of compositions 1 to 3 were as follows:

Composition 1: 10% of antistatic material based on resin content:

| | % on resin content | resin weight | Total [g] |
|---|---|---|---|
| encapsulated particles [g] | 10 | 400 | 40 |
| peroxide [g] | 2 | 400 | 8 |
| silane 12 [g] | 2 | 400 | 8 |

Composition 2: 12% of antistatic material based on resin content:

| | % on resin content | resin weight | Total [g] |
|---|---|---|---|
| encapsulated particles [g] | 12 | 400 | 48 |
| peroxide [g] | 2 | 400 | 8 |
| silane 12 [g] | 2 | 400 | 8 |

Composition 3: 15% of antistatic material based on resin content:

| | % on resin content | resin weight | Total [g] |
|---|---|---|---|
| encapsulated particles [g] | 15 | 400 | 60 |
| peroxide [g] | 2 | 400 | 8 |
| silane 12 [g] | 2 | 400 | 8 |

The electrical resistivity of the thus obtained tiles was determined according to UNE-EN-1081:2004, method A (R1) and method C (R3), respectively. Definitions that apply for the tests, according to the standard:
Vertical electrical resistivity R1: The electrical resistivity measured between a tripod electrode on the surface of a test piece and an electrode attached to the underside of the test piece.
Surface electrical resistivity R3: The electrical resistivity measured between two tripod electrodes, set up at a fixed distance of 100 mm.

Samples were kept under constant temperature and humidity conditions, specifically at 23° C. (2) and 50% (5) of relative humidity. Time spent: 115 hours. Test conditions: 49% humidity and 23° C. Load applied in both tests: 380N. Applied voltage: 500 V. Measurement taken 15 seconds after voltage connection. Five readings were taken of each sample.

The following results were obtained:

| | Composition 1 | | | Composition 2 | | | Composition 3 | | |
|---|---|---|---|---|---|---|---|---|---|
| | aver- | | | aver- | | | aver- | | |
| [×10⁷Ω] | age | max | min | age | max | min | age | max | min |
| R1* | 22.5 | 22.8 | 22.0 | 8.73 | 8.83 | 8.64 | 3.24 | 3.28 | 3.17 |
| R3** | 82.3 | 82.9 | 81.5 | 15.3 | 15.6 | 14.6 | 8.93 | 8.98 | 8.88 |

*method A
**method C

It becomes clear from the above data that all samples had excellent electrical resistivity well below 1·10⁹Ω.

Furthermore, the mechanical values measured on the tiles of the 3 compositions met the standards of the engineered stone market and are superior over conventional products:

| | Flexural [MPa] | Impact [J] | Standard Flex/Impact |
|---|---|---|---|
| Composition 1 | 76.01 | 7.1 | >50/>4 |
| Composition 2 | 74.56 | 7 | >50/>4 |
| Composition 3 | 70.56 | 6.8 | >50/>4 |

### EXAMPLE 2 (COMPARATIVE)

In accordance with Example 1 a comparative composition was prepared that differed from compositions 1 to 3 in that the encapsulated particles were omitted and a cobalt containing material was added instead:

| | % on resin content | resin weight | Total (g) |
|---|---|---|---|
| cobalt (6%) [g] | 0.2 | 400 | 0.8 |
| peroxide TBPB [g] | 2 | 400 | 8 |
| silane [g] | 2 | 400 | 8 |

The measured value of electrical resistivity was 3.26×10¹¹ Ohms.

### EXAMPLE 3

Another representative sample of the material according to the invention was tested according to ASTM F150-Standard Test Method for Electrical Resistance of Conductive and Static Dissipative Resilient Flooring.

Testing was conducted in accordance with ASTM F150. One 12″ (304.8 mm) long by 12″ (304.8 mm) wide by ½″ (12.7 mm) thick specimen was provided for testing. The specimens were conditioned at 73.4±3.6° F. (23°±2° C.) and 50±5% relative humidity for not less than 24 hours prior to testing. #

Three measurements were made of each dimension using a sliding caliper gauge. The results are summarized in the table here below:

### Test Results

| | Surface to Surface | | |
|---|---|---|---|
| Specimen | Test | Resistance | Applied |
| # | number | (Ohms, Ω) | Voltage (V) |
| Floor Tile | 1 | 1.0 × 10⁸ | 100 |
| #1 | 2 | 1.0 × 10⁷ | 100 |
| | 3 | 1.0 × 10⁸ | 100 |
| | 4 | 1.0 × 10⁷ | 100 |
| | 5 | 1.0 × 10⁷ | 100 |

1. A flooring material composition comprising
(A) an unsaturated polyester resin formulation comprising
(i) an unsaturated polyester resin component;
(ii) a metal catalyst capable of catalyzing curing of the unsaturated polyester resin component;
(iii) a quaternary ammonium salt; and
(iv) optionally, one or more additives selected from the group consisting of pigments, accelerators, co-promoters, dispersing agents, UV absorbers, stabilizers, inhibitors and rheology modifiers;
(B) particles comprising ammonium quaternary salt;
(C) an inorganic particulate material; and
(D) an initiator.

2. The composition according to claim 1, wherein the ammonium quaternary salt that is comprised in the (B) particles is a N,N,N,N-tetraalkylammonium salt, a N-phenyl-N,N,N-trialkylammonium, a N-benzyl-N,N,N-trialkylammonium salt, a N,N-diphenyl-N,N-dialkylammonium salt, a N,N-dibenzyl-N,N-dialkylammonium salt, or a N-phenyl-N-benzyl-N,N-dialkylammonium salt.

3. The composition according to claim 1, wherein the ammonium quaternary salt that is comprised in the (B) particles differs from the (iii) quaternary ammonium salt that is comprised in the (A) unsaturated polyester resin formulation.

4. The composition according to claim 1, wherein the particles are encapsulated.

5. The composition according to claim 1, wherein the particles are encapsulated by an encapsulating material selected from the group consisting of polyurethane, polyurea, polyamide, polyester, polycarbonate, a urea/formaldehyde resin, a melamine resin, polystyrene, a styrene/methacrylate copolymer, a styrene/acrylate copolymer and a mixture of any of the foregoing.

6. The composition according to claim 5, wherein the encapsulating material selected from the group consisting of polyurethane, polyurea, polyamide, polyester, and polycarbonate.

7. The composition according to claim 1, wherein the content of the particles is up to about 3%, based on the weight of the flooring material composition.

8. The composition according to claim 1, wherein the particles have an average particle size of about 10 μm to about 250 μm.

9. The composition according to claim 1, wherein the unsaturated resin polyester resin component further comprises a reactive diluent.

10. The composition according to claim 9, wherein the reactive diluent is selected from the group consisting of styrene, substituted styrene, nono-, di- and polyfunctional esters of monofunctional acids with alcohols or polyols and mono-, di- and polyfunctional esters of unsaturated monofunctional alcohols with carboxylic acids or their derivatives.

11. The composition according to claim 1, wherein the unsaturated resin polyester resin component is cobalt free.

12. The composition according to claim 1, wherein the metal catalyst comprises zinc or copper.

13. The composition according to claim 1, wherein the (A)(iii) quaternary ammonium salt is a benzyl-N,N,N-trialkylammonium salt or a N,N,N,N-tetraalkylammonium salt.

14. The composition according to claim 1, wherein the unsaturated polyester resin component is obtained by reacting a mixture comprising a multicarboxylic acid component and a polyhydric alcohol component, wherein the multicarboxylic acid component and/or the polyhydric alcohol component comprises ethylenic unsaturation.

15. The composition according to claim 14, wherein the multicarboxylic acid component is selected from the group consisting of aliphatic dicarboxylic acids, aliphatic tricarboxylic acids, aliphatic tetracarboxylic acids, aromatic dicarboxylaic acids, aromatic tricarboxylic acids and aromatic tetracarboxylic acids; and the polyhydric alcohol component is selected from the group consisting of aliphatic diols, aliphatic triols, aliphatic tetraols, aromatic diols, aromatic triols and aromatic tetraols.

16. The composition according to claim 1, wherein the inorganic particulate material comprises quartz aggregates and/or quartz fillers.

17. The composition according to claim 16, wherein the quartz aggregate comprises about 25% to about 75%, by weight of the flooring material composition, of particles having a particle size of up to about 0.3 μm and about 5% to about 30%, by weight of the flooring material composition, of particles having a particle size of greater than about 0.3 μm and the quartz filler has a particle size of up to about 45 μm and the content of the quartz filler in the flooring material composition is about 15% to about 35% by weight of the flooring material composition.

18. The composition according to claim 1, wherein the initiator comprises peroxide.

19. The composition according to claim 18, wherein the peroxide comprises cumene hydroperoxide and/or methyl isobutyl ketone peroxide.

20. The composition according to claim 1, wherein the composition is cobalt free.

21. A flooring material composition comprising i) a resin selected from the group consisting of vinyl ester resin and epoxy resin and ii) particles comprising ammonium quaternary salt.

22. A flooring material comprising the flooring material composition according to claim 1 in cured form.

23. The flooring material according to claim 21 having electric resistivity values within the dissipative established zone.

24. A method for the making flooring material comprising the steps of
(a) preparing a formable composition by mixing
(A) an unsaturated polyester resin formulation comprising
(i) an unsaturated polyester resin component;
(ii) a metal catalyst capable of catalyzing curing of the unsaturated polyester resin component;
(iii) a quaternary ammonium salt; and
(iv) optionally, one or more additives selected from the group consisting of pigments, accelerators, co-promoters, dispersing agents, UV absorbers, stabilizers, inhibitors and rheology modifiers;
(B) particles comprising ammonium quaternary salt;
(C) an inorganic particulate material; and
(D) an initiator;
(b) forming the composition prepared in step (a) into a desired shape; and
(c) allowing the composition formed in step (b) to cure.

25. The method according to claim 24, wherein the composition formed from steps (a), (b) and (c) is an engineered stone slab and comprising an additional step (d) of making a piece of flooring material from the engineered stone slab.

26. The method according to claim 24, wherein the unsaturated polyester resin formulation is cobalt free.

27. The method according to claim 24, wherein the metal catalyst comprises zinc or copper.

28. A piece of flooring material made by the method of claim 24.
